(19) United States
(12) Patent Application Publication
(10) Pub. No.: US 2017/0072542 A1
(43) Pub. Date: Mar. 16, 2017

(54) CLAMPING RATCHET WRENCH

(71) Applicant: Ali W Eldessouky, Lawrence, MA (US)

(72) Inventor: Ali W Eldessouky, Lawrence, MA (US)

(21) Appl. No.: 15/123,202

(22) PCT Filed: Mar. 4, 2014
(86) PCT No.: PCT/US14/20438

§ 371 Date: Sep. 1, 2016

Related U.S. Application Data
(63) Continuation-in-part of application No. 13/114,973, filed on May 24, 2011, now Pat. No. 8,661,945.

(51) Int. Cl. B25B 13/46

(52) U.S. Cl. CPC B25B 13/463

(57) ABSTRACT

A single piece housing surrounding individual ratchet key segments providing a clamping ratcheting wrench that is capable of being opened and closed without slipping the wrench over the end of a nut to be tightened or loosened. This wrench overcomes many problems because it may be used on a nut that is in a very tight position where a traditional wrench would not fit, nor would a conventional wrench be capable of ratcheting. The ratchet is effected by individual ratchet segments that are held in place when the wrench is opened. One of the true advantages of the various aspects is that the ratchet can be opened and closed once the ratchet segments are aligned, such that the segments are secured in place to allow the wrench to be opened up without having all the segments fall out of the wrench. A first aspect of the invention discloses an interlocking ratchet piece design, while a second aspect of the invention discloses another ratchet piece design with structural channeling to secure the ratchet segments in alignment so that the segments do not come out of the wrench.

### CROSS-REFERENCE TO RELATED APPLICATIONS

This application claims the benefit under 35 U.S.C. 119(e) of U.S. Provisional Application No. 61/347,636 filed on 24 MAY 2010. This application is a Continuation-In-Part Application of U.S. application Ser. No. 13/114, 973, now issued U.SA. Pat. No. 8,661,945.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED, INCLUDING ON A COMPACT DISC

Not Applicable

### TECHNICAL FIELD

This invention relates to an open ended ratchet wrench, and more particularly relates to a clampable open ended ratchet wrench.

### BACKGROUND OF THE INVENTION

There has been a long felt need for a clampable open ended ratchet wrench that can be opened and closed to tighten a nut in a situation where the conventional closed end ratchet wrench cannot be slipped down onto the nut to be tightened or released, such as in the middle of a pipe, where access to the nut is quite limited. Inserting a wrench around a nut that is midway located in a pipe or other fitting, sometimes occurring under a sink, or within a kitchen cabinet, has plagued many a plumber. Needless to say, there are many other circumstances where the tight quarters could advantageously employ a new type of clamping ratchet wrench. In certain circumstances, it is nearly impossible to utilize a classic crescent wrench, because there is not enough space to move the lever and the wrench handle to provide quick and effective wrenching action.

Traditionally, a long pipe with a nut in the middle that required tightening was tightened with an open end crescent wrench. This job is slow and tedious. For obvious reasons, a ratchet wrench would be preferable for this task, although heretofore, there has not been a clampable open ended ratchet wrench that was available that could apply full pressure all the way around the nut. In trying to solve this problem by coming up with a solution, prior art attempts have yielded various configurations with a ratchet on a separate piece that twirls or swings around the nut to be tightened or loosened, but this also requires a certain amount of space that may not be available to the user.

U.S. Pat. No. 4,327,610, issued to Angelo Chiarenza on May 4, 1982, discloses an open end wrench that includes a slot to receive a nut, along with spring segments that project inwardly to act as the ratcheting device. The ends of the segments turn on the flat surfaces of the nut when the wrench is turned in the tightening direction. In order to effect a ratchet action, the cantilever springs flex to skim over the corners of the nut and then spring back to apply pressure to the flat surfaces of the nut. However, the open ended wrench does not completely surround the nut to provide full and complete engagement of all surfaces to provide maximum torque.

Another invention attempting to solve this problem of allowing for a ratchet wrench in a limited access mid-pipe nut tightening situation is embodied in various promotions, including the use of split socket wrenches that include swinging arm members so that the wrench can be opened. The swinging arm member can then pivot out and around the nut and is clamped back on top of itself toward the handle before the ratcheting action is made possible. This swinging member is not automatically put into place, but rather requires a bit of work on the part of the operator. Further, it may require enough of a clearance behind the pipe with the nut in the middle, so as to prevent the swinging arm from swinging into proper position. In that regard, U.S. Pat. No. 4,562,757, issued to James Furey on Jan. 7, 1986, discloses such a split socket wrench including a swinging arm member for enclosing the nut. This device would be impossible to use under many conditions. A better design is needed for a clamping ratcheting open end wrench.

Therefore, there has been a long felt need for a clamping ratchet wrench that automatically opens and closes around a nut so that the ratcheting operation can be maneuvered in limited access spaces. An automatic wrench would be most advantageous, and the industry would welcome such an invention. In that regard, the industry is now ready for a clamping ratchet wrench which can be effectively utilized in very close quarters. Especially useful would be a ratcheting wrench which can be opened and closed when pressed up against a nut.

### SUMMARY OF THE INVENTION

In accordance with the above-noted desires of the industry, the present invention provides various aspects, including a clampable ratcheting wrench that is capable of being opened and closed without slipping the wrench over the end of a nut to be tightened or loosened. Also disclosed is a method of making same, and a method of using the wrench.

This wrench overcomes many of the aforementioned problems with the prior art because the present invention may be used on a nut that is in a very tight position where a traditional wrench would not fit, nor would a conventional wrench be capable of ratcheting.

The ratchet is effected by individual ratchet segments that are held in place when the wrench is opened. One of the true advantages of the various aspects is that the ratchet can be opened and closed once the ratchet segments are aligned, such that the segments are secured in place to allow the wrench to be opened up without having all the segments fall out of the wrench.

A first aspect of the present invention includes certain features including a ratcheting portion which can be opened to go around a nut to be tightened rather than slipping the ratchet over the nut. Prior open end ratchet wrenches utilized a swing-around arm to effect a fully closed ratchet, although there are many instances where there just is not enough room to accommodate a swing-around arm. The present invention overcomes that problem by opening in the wrench itself to provide a very tight clearance, such that the wrench can be used in impossibly tight quarters. Once opened, the ratchet segments stay in place after alignment, so that the segments do not fall out.

The first aspect of the invention discloses an interlocking ratchet piece design, while a second aspect of the invention discloses another ratchet piece design with structural channeling to secure the ratchet segments in alignment so that the segments do not come out of the wrench.

The second aspect of the present invention discloses another ratchet segment design which differs from the design of the first aspect because rather than the segments interlocking with each other, the segments are carried on a channel formed into the upper and lower clamp housings. Once aligned, and the segment pieces are secured, then the wrench can be opened.

A third aspect of the present invention discloses an open ended ratchet wrench having a one piece housing that operates with a notched key rotation system to give a positive ratcheting action, as described more fully hereinbelow.

Yet another aspect of the present invention discloses an automatically adjusting spring loaded system for ease of ratcheting against the nut that is being tightened, as in my other aspects of this present invention.

### BRIEF DESCRIPTION OF THE DRAWINGS

For a further understanding of the nature and advantages of the expected scope and various aspects of the present invention, reference shall be made to the following detailed description, and when taken in conjunction with the accompanying drawings, in which like parts are given the same reference numerals, and wherein:

FIG. 1 is an exploded perspective view of a first aspect of a clampable ratchet wrench made in accordance with the present invention;

FIG. 2A is a perspective view of the wrench with the open end in the open position;

FIG. 2B is an environmental perspective view of the wrench being used to tighten a nut;

FIG. 3A is a top plan view of the wrench in a closed position;

FIG. 3B is a top plan view of the wrench in an open position;

FIG. 3C is a top plan view of the wrench in a semi-closed position;

FIG. 4A is a cross sectional view of the inner workings of the first aspect of the invention;

FIG. 4B is a perspective view of the inner workings of the first aspect of the invention;

FIG. 4C is an exploded view of a portion of the invention;

FIG. 5 is an exploded view of the ratchet pieces illustrating the interlocking feature of the first aspect of the invention;

FIG. 6 is a top perspective view of a single ratchet segment;

FIG. 7 is a top plan view of the interlocking ratchet segments of FIG. 5 when interlocked;

FIG. 8 is a top plan view of a single ratchet segment;

FIG. 9 is a top plan view of the wrench in a nearly closed position, with a close up window of the twisting mechanism;

FIG. 10 is a perspective view of a second aspect of the present invention;

FIG. 11 is a bottom cross-sectional view of the wrench, showing the relative placement of the lock and the lock spring constructed in accordance with the present invention;

FIG. 11A is a rear perspective view of an individual ratchet segment;

FIG. 11B is a front perspective view of the ratchet segment of FIG. 11A;

FIG. 11C is a perspective view of a release slide;

FIG. 11D is a perspective view of a gear used with the retractable slide;

FIG. 12 is a top plan view of the second aspect of the present invention in an open position;

FIG. 13 is a top plan view of the second aspect of the present invention in an semi-open position;

FIG. 14 is a top plan view of the wrench with the upper clamp housing removed to show the inner workings;

FIG. 14A is a perspective view of a lock pawl front elevation;

FIG. 14B is a side elevational view of the lock pawl;

FIG. 14C is the rear elevational view of the lock pawl;

FIG. 14D is the top plan view of the lock pawl;

FIG. 15 is a front perspective view of a ratchet pawl;

FIG. 16 is a top plan view of the wrench with the upper clamp housing removed to show the inner workings while the teeth are engage to illustrate how the lock pawl open to stop the lock;

FIG. 17A is a cutaway side elevational view of lock balls in a lockdown position;

FIG. 17B is a cutaway side elevational view of lock balls in an open position;

FIG. 17C is a top view of the ratchet segment illustrating the alignment guide;

FIG. 18A is a side elevational cutaway view of lock pins in a closed position;

FIG. 18B is a side elevational cutaway view of lock pins in an open position;

FIG. 19 is an exploded view of the component parts of the second aspect of the invention;

FIG. 20A-20B show perspective views of a one-piece housing of another aspect of the present invention;

FIG. 21 is a top perspective view of the one-piece housing aspect, but only showing the bottom half of the one-piece housing sliced horizontally through the housing to show the interior pieces within the wrench;

FIG. 22 is a side elevational view of the bottom half showing the relative placement of the ratchet keys and a pair of plates holding the ratchet keys in place;

FIG. 23A-23E show various angles of the individual ratchet key, illustrating the notches, key faces and key skags;

FIG. 24 is an exploded view of this aspect of the present invention with the top and bottom plates holding the keys in position within the housing;

FIGS. 25A and 25B show an environmental view of yet another aspect of the invention with pivoting ratchet keys approaching a workpiece and engaging a workpiece, respectively;

FIGS. 26A-26D illustrate the pivoting ratchet keys and the ratchet spring permitting ratcheting against a nut, without the use of a pawl;

FIGS. 27A-27D provide more detailed drawings of the actual pivoting ratchet keys, the pivot and the spring; and

FIG. 28 shows a full perspective view of a open ended ratcheting wrench made in accordance with the present invention with a traditional wrench at one end and my novel wrench at the other.

Although the invention will be described by way of examples hereinbelow for specific aspects having certain features, it must also be realized that minor modifications that do not require undo experimentation on the part of the practitioner are covered within the scope and breadth of this invention. Additional advantages and other novel features of the present invention will be set forth in the description that follows and in particular will be apparent to those skilled in the art upon examination or may be learned within the practice of the invention. Therefore, the invention is capable of many other different aspects and its details are capable of modifications of various aspects which will be obvious to those of ordinary skill in the art all without departing from the spirit of the present invention. Accordingly, the rest of the description will be regarded as illustrative rather than restrictive.

### DETAILED DESCRIPTION OF THE INVENTION

The present clamping ratchet wrench invention disclosure includes various aspects of the invention, each including a series of individual ratchet key segments that can remain in the wrench while it is being opened and closed in synchronicity in an automatic fashion. Such aspects help to provide a wrench that can be clamped around a pipe with a nut surrounding the pipe, and then ratcheted to tighten or loosen the nut. The present invention also discloses a clamp ratchet wrench that includes a finger operable retractable handle that when retracted, the clamp automatically opens due to a spring action, and can be pressed directly against the nut of a pipe that needs to be tightened. When the clamp ratchet wrench of the present invention is pressed against the nut and the finger operable retractable closing device is pushed toward the pipe, the interlocking key mechanisms are automatically aligned and the clamp wrench portion automatically closes around the nut.

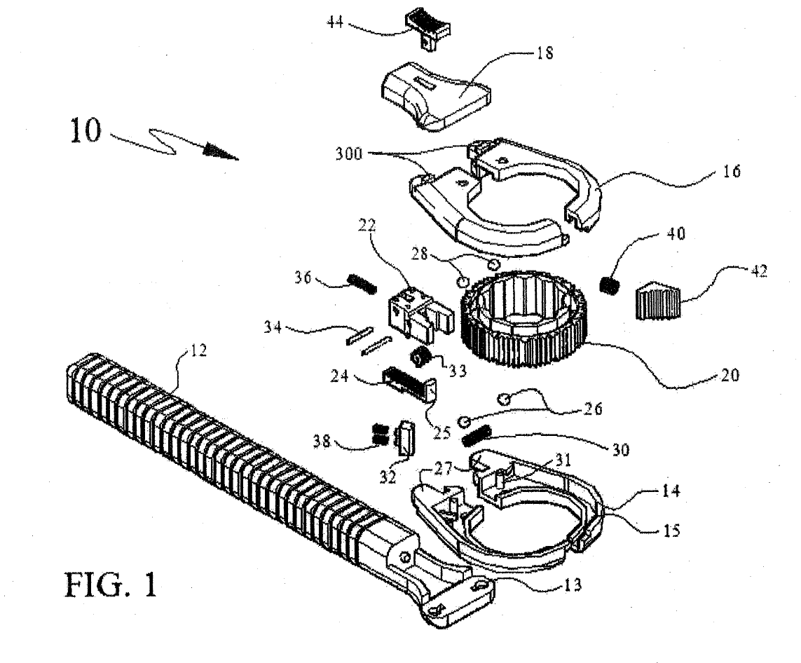

This very clever device utilizes an entirely new form of ratcheting key mechanisms, although it utilizes a pawl as is common in normal ratcheting devices. The various aspects of the invention disclose ratchet key designs which are new, and not shown before in other wrench configurations. This new and novel wrench design will be described more fully herein below with reference to FIGS. 1-28, detailing the mechanisms.

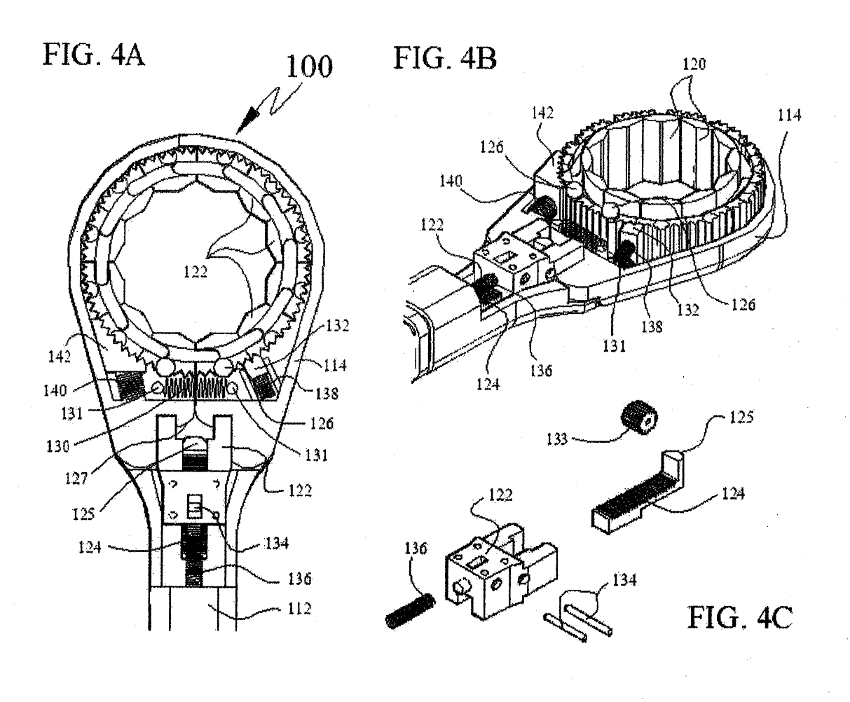

Looking first to FIG. 1, there is shown an exploded perspective view of the clamp ratchet wrench of the present invention, generally denoted by the numeral 10. The wrench includes a handle 12 which receives a lower clamp housing 14 on its distal end. Within the proximal end of the ratchet wrench handle 12, there is a clamp lock and pivot aperture 13 which allows the lower clamp housing 14 to rotate and pivot to open and close around the nut. An upper clamp housing 16 includes an indented portion which forms a race 15 to receive ratchet keys 20. Upper and lower clamp housings 14 and 16 are operated by the use of a retractable latch button 44 that works in conjunction with a lock 22. Underneath lock 22 is a separation lever 24 that includes a rounded head 25, one of the clever innovations of the present invention. The function of the rounded head for automatically aligning certain components will be discussed more fully herein below with reference to FIG. 4A and 4B.

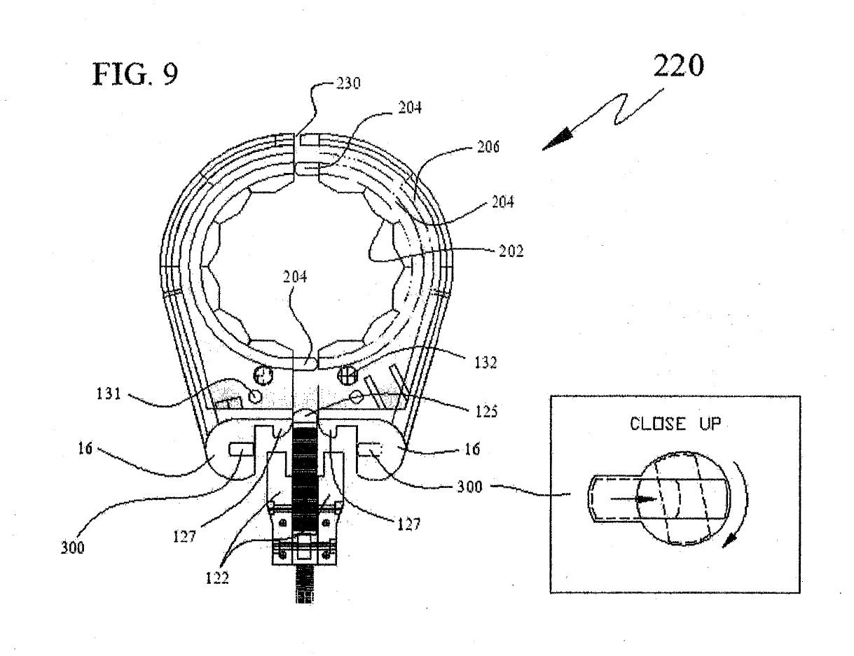

Still referring to FIG. 1, a set of lower and upper alignment balls 26 and 28, respectively, are carried in indentations on the inside of both the upper and lower clamp housing 14 and 16, respectively. As the ratchet keys 20 rotate, the upper and lower alignment balls 26 and 28, respectively, fall in the indentations located on the top and bottom of each ratchet key 20 indicating that the ratcheting keys 20 are aligned allowing the wrench to open if the operator retracts the retractable latch button 44. Hips 27 included in the design of the lower and upper clamp housings are in operable communication with the rounded head 25 of separation lever 24. Although they may be any suitable configuration, dogs 300 are semi-rectangular posts extending into an aperture within hips 27. Dogs 300 can help to open up the clampable ratchet wrench of the present invention, and are more fully described hereinbelow with reference to FIG. 9.

Clamp spring 30 attaches to a clamp spring post 31 and acts to retract the clamping the upper and lower clamp housings to bring the wrench automatically back into place.

Ratchet key lock 32 will become operably engaged with gear teeth on the back of ratchet keys 20 during operation. Ratchet lock springs 38 put the ratchet key lock 32 into position in order to prevent ratchet keys 20 from sliding out of upper and lower clamp housing 6 and 14, respectively, when separation lever track gear 33 moves upwardly and urges separation lever 24 into operation. Button lock-in pins 34 hold the track gear 33 and the retractable latch button 44 in place, such that track gear 33 is used to urge separation lever 24 forward or backward to engage or disengage the housings into position around the nut. Lock spring 36 is attached to the back of lock 22 to automatically push lock 22 forward consequently locking upper housing clamp 16 and lower housing clamp 14.

The ratcheting keys 20 have gear faces on their backside. These gear faces have been engineered to mate against the surface of a pawl 42 which is kept in place by pawl spring 40. A retractable latch button 44 is used by the operator with a thumb action to push the lock on the track gear backward and forward to press the upper and lower housings into their clamped and unclamped positions.

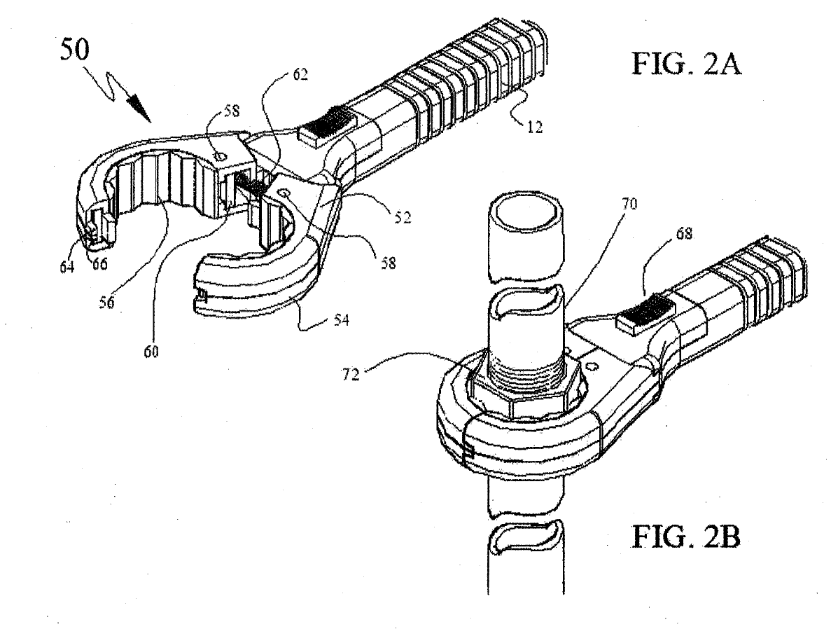

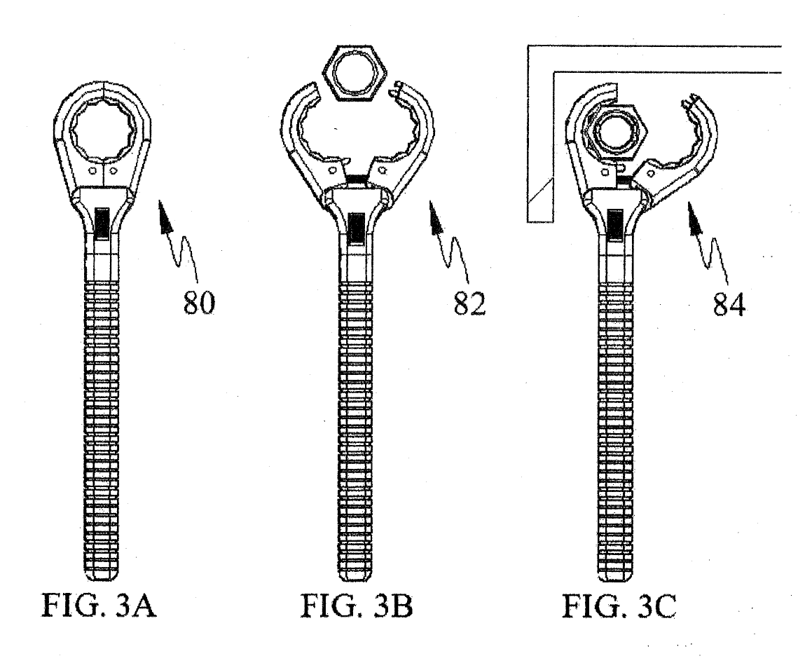

Looking next, with combined reference to FIGS. 2A and 2B, there is seen another perspective view of the clamp ratchet wrench generally denoted by numeral 50 including upper and lower clamp housings 52 and 54, respectively. The individual ratchet keys 56 are shown as indicating proper placement by alignment balls 58. From the side, the key push face 60 can be seen in this Figure and the mechanism is operated when the operator rotates the wrench while clamped around nut. At the distal opening of the clamping housing, there are upper and lower clamp alignment guides 64 and 66, respectively, which are received in the other side of the clamping housing. The retractable latch button 68 is positioned by the thumb of the operator, thereby opening and closing the clamping mechanism 50 around nut 72 fastened to a pipe 70. The interim stages of the utilization of the present invention are now to be disclosed with regards to FIGS. 3A to 3C.

With combined reference now to FIGS. 3A through 3C, there can be seen the various mechanisms by which the present invention can be utilized. The entirely closed clamping mechanism is generally denoted by numeral 80, in FIG. 3A, while the entirely open mechanism is denoted by numeral 82 as shown in FIG. 3B. As one can see from this drawing, the wrench approaches the nut in an open position, and then the latch button shown on top can be utilized to clamp the wrench around the nut into the closed position. FIG. 3C illustrates the partially opened configuration 84, where the pipe is too close to the corner of a limited access area. In this situation, only one half of the clamping mechanism can be opened up. However, utilizing the latch button, it can still be closed and then ratcheted to tighten.

Referring next to FIG. 4A through 4C, FIG. 4A is a top planned view of the interworking, and is generally denoted by numeral 100 and includes handle 112 onto which clamp housing 114 is rotatably engaged. The individual ratchet keys 120 can be seen in their closed position. The lock 122 sits on top of, and is engaged with, separation lever 124 having a rounded head 125. The alignment balls 126 are shown in position on of ratchet keys 120 that are on top of horizontal lock housing 127. Clamp spring 130 is secured by posts 131, while the ratchet key lock 132 that engages the rear geared portion of ratchet keys 120 is urged into position by ratchet lock spring 138.

Now let us look at how the mechanism works. As lock 122 rides up and down on separation lever 124 on its track, the rounded head 125 is pushed upwardly against hip 127 which pushes the housing 114 apart. The lock spring 136 retracts the lock 122 after operation.

To more carefully see how the alignment balls work, FIG. 4B is a front perspective elevational view where the alignment balls 126 sit in the indentations in the top of ratchet keys 120. Pawl 142 is held in engagement with the ratchet keys by pawl spring 140 when lock 122 is urged forward by the lock spring 136.

FIG. 4C illustrates the interworkings of the lock mechanism which includes the lock itself 122 which is kept in place by lock spring 136. Within the contours of lock 122 is a track (not shown in this figure) for receiving the geared upper portion of the separation lever 124. Track gear 133 rolls against the upper geared portion of separation lever 124 and is held in place by button lock-in pins 134.

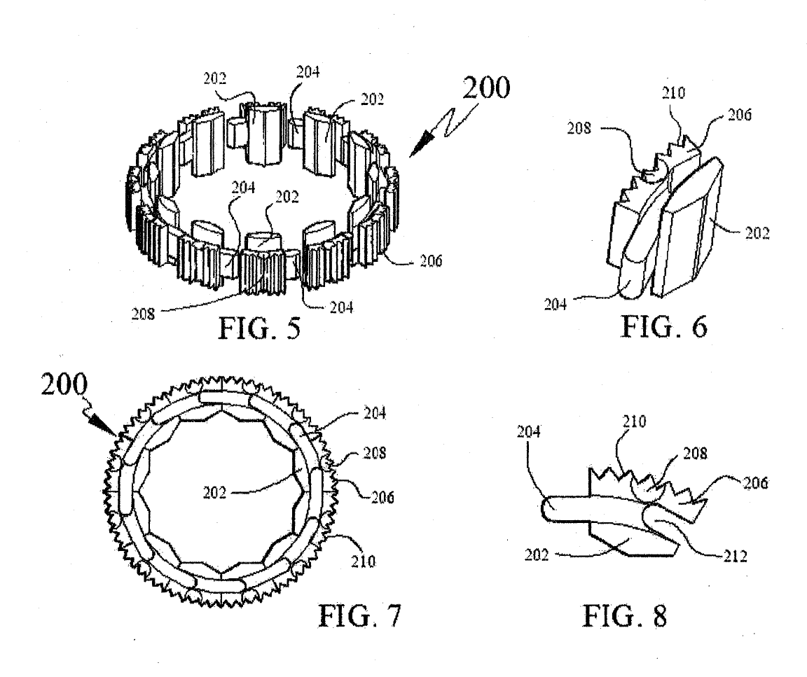

Looking next to FIG. 5, the individual ratchet keys, here generally denoted by the numeral 200, include individual interlocking keys that roll in a race of the clamping housings shown in the other Figures. Each of the ratchet keys include a segment face 202 for receiving the flat surfaces of the nut being tightened, and also include a ratchet key blade 204 that separatably interlocks the various ratchet segments 202 to form the overall ratchet key 200. On the backside of the individual ratchet segments 202 is a geared portion pawl catch 206 for engagement with the pawl. On top of the ratchet segments, there are alignment ball indentation receivers 208, useful for aligning the various components in an automatic fashion. Ratchet key blades 204 are received within an indentation, shown most clearly in FIG. 8, described below.

FIG. 6 is a close up perspective view of an individual ratchet segment 202 clearly showing the relative placement of the ratchet key blade 204, the pawl catch 206, the alignment ball indentation receiver 208, and the pawl catch faces 210 formed in the outer surface.

FIG. 7 shows the interconnectivity of all the ratchet segments when they are in a closed position, and show how the ratchet segments abut one another when they are in the closed position.

FIG. 8 is a top plan view of ratchet segment 202 clearly showing the ratchet key blade 204, pawl catch 202 having pawl catch faces 210 formed in their backside, and alignment ball indentation receiver 208. Ratchet key receiver aperture 212 is sized and adapted for receiving the ratchet key blade 204.

FIG. 9 is a top plan view of the working distal end of the clamp ratchet wrench of the present invention. This working end is generally denoted by numeral 220 and show the front faces 202 with an exposed interlocking keyblade 204 disengaged from its adjacent key. Clamp housing 16 provides the structure for opening and closing the wrench. As the clamp wrench is opened by the rounded head 125 being urged upward to force spreader hips 127 apart, dogs 300 are semi-rectangular posts extending into an aperture shown in the close-up shadow in this FIG. 9. The lock 122 sits on top of, and is engaged with, separation lever 124 having a rounded head 125.

FIG. 9 is accompanied by a close up vignette illustration showing the relative placement of dogs 300 as they extend into the slot and then are forced outwardly into the round aperture, thereby permitting full rotation. Once dog posts 300 are rotated within the rounded aperture, the housing is forced apart, thereby disengaging keyblades 204 at the outer most circumference and at the innermost circumference. Once the keyblades clear their engagement point from behind face section 202, the clamp ratchet wrench can be opened up as shown more clearly with respect to FIGS. 3A-3C.

The aspect of the invention described above discloses the interlocking ratchet key designs which enable this clamp ratchet wrench to open at nearly any location around the clamp housings shown in the Figures above. It is this interlocking ratchet key, in combination with the hip opening action of the rounded head in the lock track gear mechanism, which renders this invention new and non-obvious over prior art attempts at solving the same problem. In addition, the utilization of the alignment balls keep each of the interlocking ratchet segments in proper position when the clamp is open and ready for action. Various springs help to keep the ratcheting action going are utilized, with a clamp spring secured by posts 131.

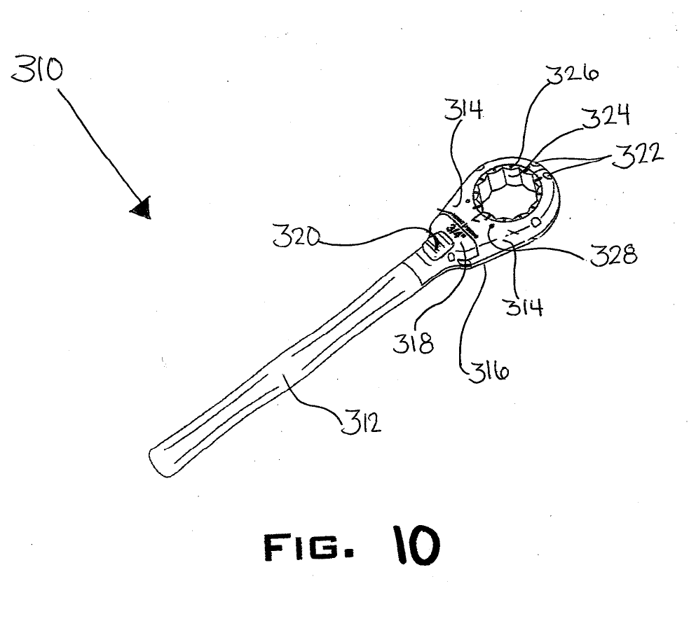

FIG. 10 is a perspective view of yet another aspect of the present invention, with a second design for the ratchet segments engagement and disengagement. This second aspect is generally referred to by the numeral 310, and includes a handle 312 with a ratchet upper clamp housing 314 secured on top of a ratchet lower clamp housing 316 at the distal end of the handle. Clamp cover 318 houses the underlying mechanism, detailed more fully hereinbelow with reference to further drawings. Retractable latch button 320 is operable by the user to open and close the clampable ratchet wrench. Clamp housing fasteners 322 secure the upper and lower clamp housings 314 and 316, respectively. Individual ratchet segments 324 are shown. Alignment guides 326 are located on the top of the ratchet segments 324, and they are used to keep the individual segments 324 aligned for proper usage. Alignment pins 328 extend slightly above the upper surface of the upper clamp housing 314, so that the user can feel when the pins 328 are extended. When the pins 328 extend upwardly enough for the user to feel them, then the user knows that the ratchet segments 324 are in alignment such that the wrench 310 can be opened.

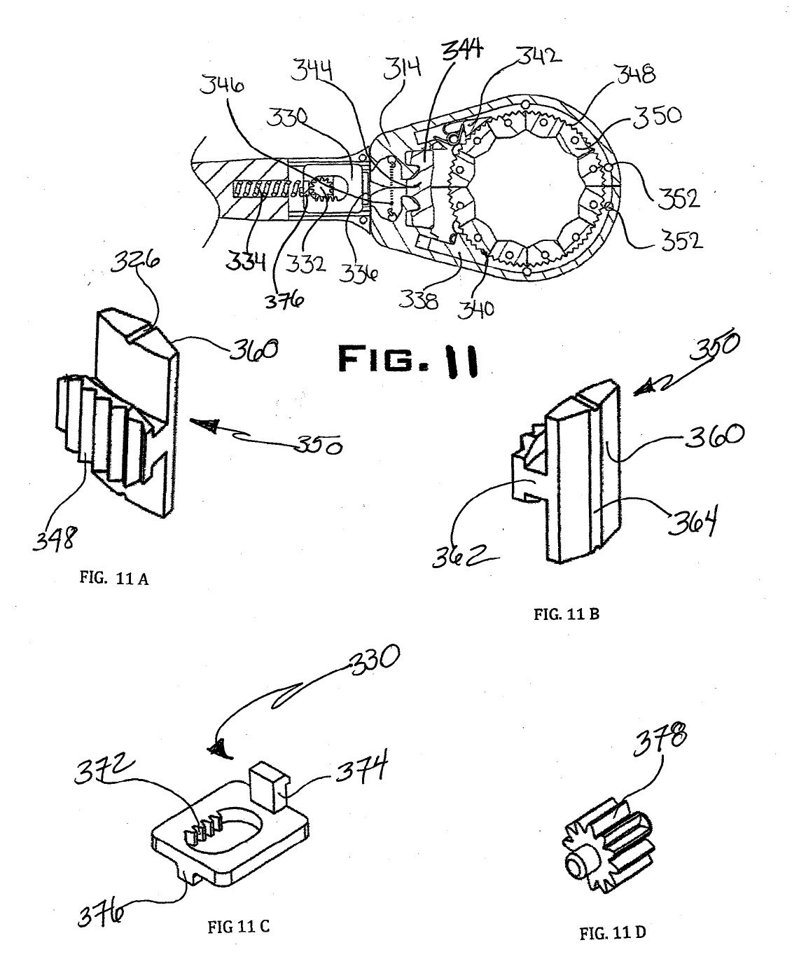

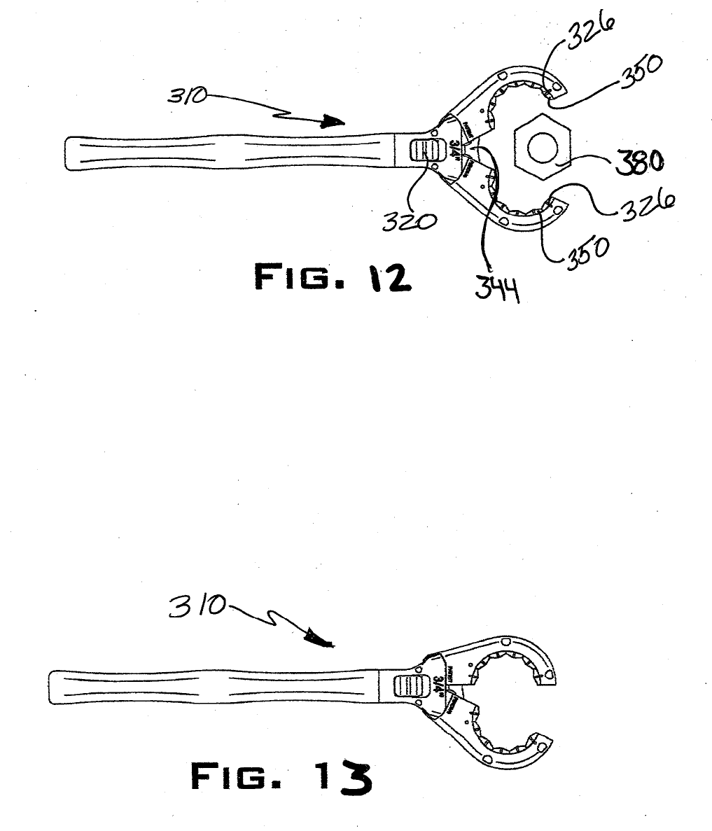

FIG. 11 illustrates how the release slide 330 moves the release gear 332 against lock spring 334. Clamp spring 346 holds upper clamp housing 314. Ratchet teeth 348 of ratchet segments 350. Ratchet teeth 348 engage pawl teeth 340 on the face of the pawl 338. Fasteners 352 hold together the upper clamp housing 314 from lower clamp housing 316 (not shown in this view). Lock pawl 342 is diametrically opposed to pawl 338, and is pushed into position by lock 344. Hence, when the release slide 330 is pulled backward, the release gear 332 pushes lock 344 forward to open the ratchet as more fully shown in reference to FIG. 12 below. Lock spring 334 urges the release slide 330 to maintain in a closed position unless forced open.

Referring now to FIG. 11A, ratchet segment 350 is shown with ratchet teeth 348 extending from the middle portion, with a reduced dimension channel between it and the ratchet segment face piece 360. The channel that is created rides in a channel that is formed by the upper and lower clamp housings, 314 and 316 respectively, so that the segment pieces do not fall out of the housings when the wrench is opened up. Alignment guide 326 helps to put all of the segments in alignment so that when the wrench is opened, the pieces do not fall out because, once aligned, locking pins hold in the segment pieces as described more fully hereinbelow.

Looking next to FIG. 11B, the opposite side of ratchet segment 350 is shown including the face 360 of the ratchet segment. The channel riding portion 362 will be contained within the grooves created by the two housings coming together. The segment face 360 will act as the pressure point against the nut that is desired to be tightened or loosened. The flattened groove 364 on part of the face 360 helps in the alignment and locking procedure.

Looking next to FIG. 11C, release slide 330 shows the relative placement of the slide gear teeth 372 that ride on gear 378 shown in FIG. 11D. Slide gear teeth 372 mate with the ratchet gear teeth 378 and work to move the lock 344 into position. Button clip 374 engages the release slide 330 to the retractable slide button on the face of the tool itself, while the lock spring support 376 acts as a resting place for lock spring 334 as shown in FIG. 11. Lock spring support 376 urges spring 334 back to its recoiled position in operation.

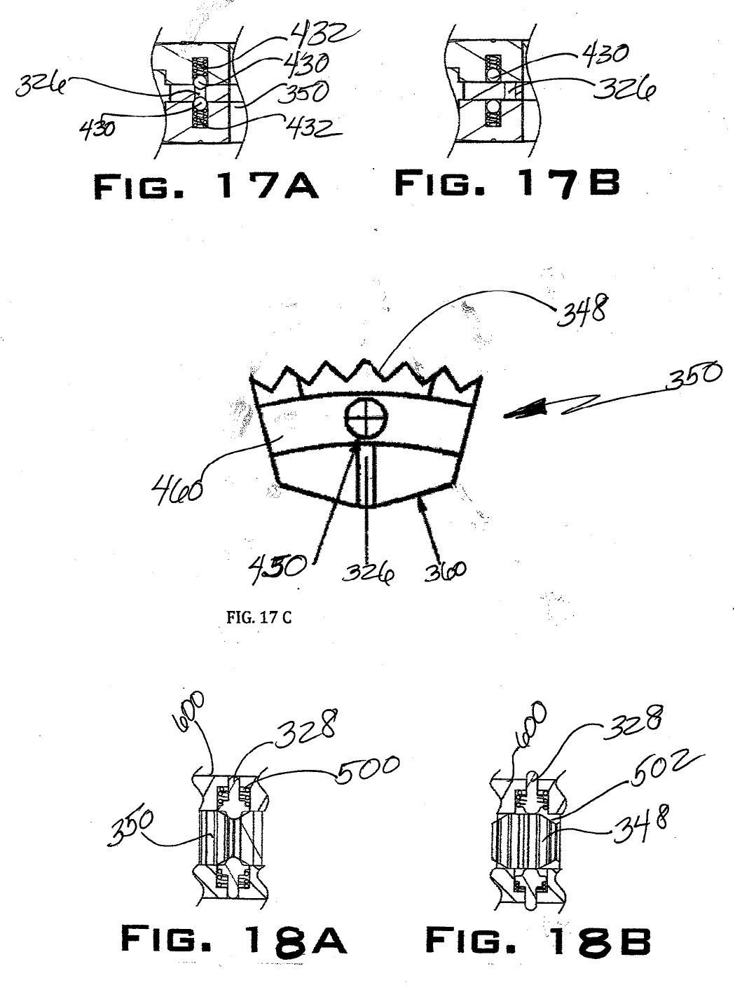

Referring next to FIG. 12, wrench 310 is shown in an open position with the lock 344 urged forward by pulling back on the retractable button 320. Note that when the operator pulls back on the retractable button 320, lock 344 is urged forward through the clamping portion of the wrench in the opposite direction from the handle. By pulling back on button 320, the gear mechanism of the release slide 330 of FIG. 11C is pushed in the opposite direction, so that lock 344 is urged forward when release button 320 is pulled back. When an operator wants to open the clamping wrench to surround a nut 380, the clamp is opened. As one can see from FIG. 12, the ratchet segments 350 stay in place because the alignment guides 326 have become aligned with the lock pin arrangement, more carefully shown with regards to FIGS. 17A and 17B. For now, it suffices to know that once the alignment guides 326 are in position, the locks can be effected, locking in the ratchet segments 350 so that they do not come out. Once the wrench is in proper position around nut 380, the wrench is closed and the ratcheting action can begin.

FIG. 13 shows how the clamping wrench can have only one half of the clamping device open at a time, which may be very useful in extremely tight situations where the ratcheting portion needed to fit around a nut has a physical hindrance in very close proximity, necessitating the use of a half open ratchet wrench.

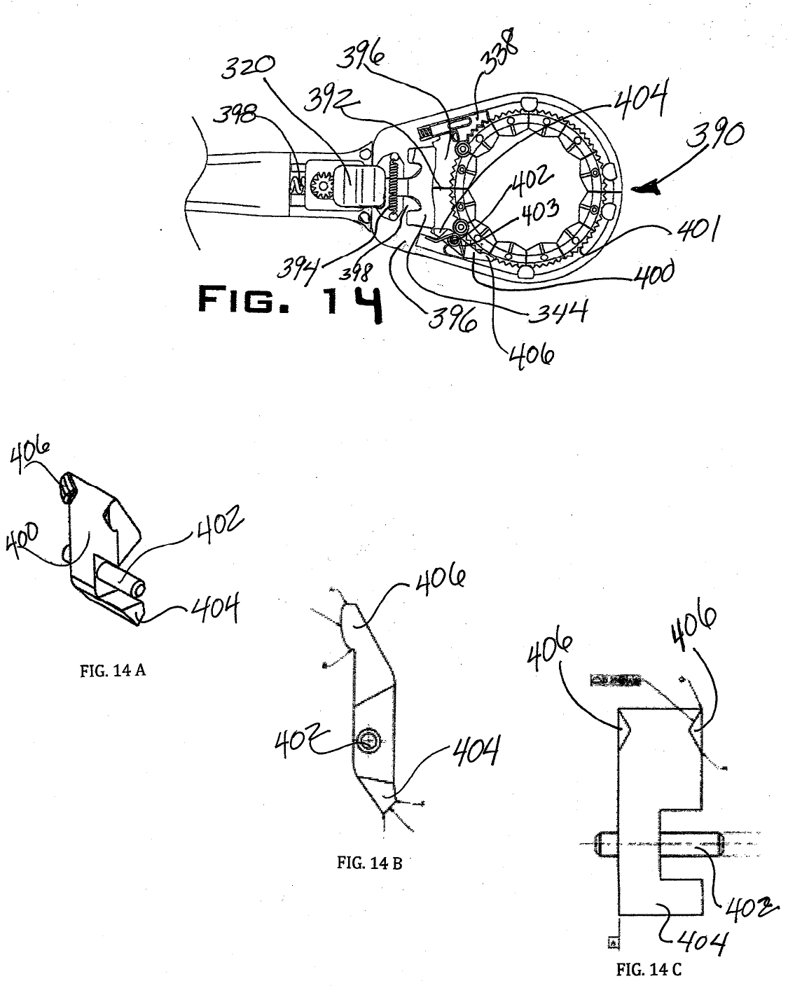

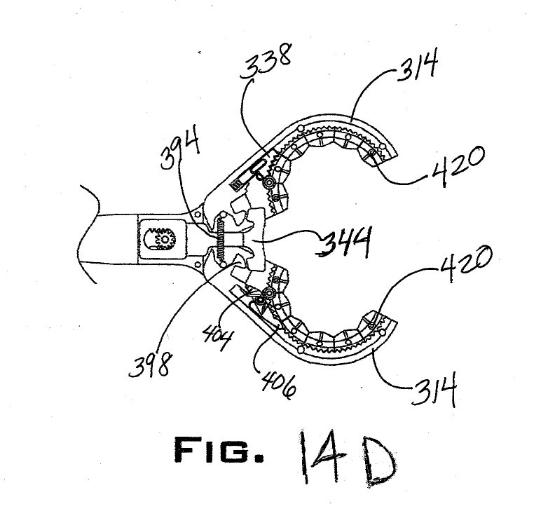

FIG. 14 shows the clampable ratchet wrench locked in a retracted position. When the operator pulls back on the retractable button 320, this drives the lock forward, thereby releasing lock key 398 so that the wrench can pivot forward and allow the wrench to open at the breaking points 390 and 392. Clamp spring 394 helps to hold together clamp housing 396 as all components are urged forward by lock spring 398 holding the lock in place. Lock 344 pushes against clamp housing 396 and holds the ratchets in place.

As there are many pieces to be considered here, we are separately taking FIG. 14A to show the front view of the lock pawl 400. The spring receiver 402 also acts as the axis for pivoting described above with reference to FIG. 14. Lock pawl 400 has a pawl catch 406 that is received by indentations in pawl teeth 401. The lock stop 404 catches on lock 344 when in position and allows the lock to push forward, breaking open the wrench. This may be seen in greater detail in FIGS. 12 and 13 when lock 344 is extended forward releasing the clamp housing halves. Lock pawl 400 ends up in proper position when pawl catch 406 is received by indentations in pawl teeth 401. As can be seen in FIG. 14, lock pawl 400 has a spring receiver 402 which also acts as the axis for pivoting to receive spring 403, which holds lock pawl in place.

FIG. 14B is a side elevational view of the lock pawl showing the side dimension of the lock pawl hook 404 and lock pawl catch 406.

FIG. 14C shows a rear elevational view showing the spring receiver 402, lock pawl hook 404, and lock pawl catch 406.

FIG. 14D shows the ratchet wrench in an open position, and clearly shows lock 344 in a fully forward position where the clamp key 398 is disengaged, and lock pawl 400 is properly positioned to properly allow lock key 344 to move forward disengaging with clamp key 398. Once clamp key 398 is disengaged and lock 344 is pushed forward, clamp housings 314 can swing out after the ratchet segments are locked in place by lock pins 420.

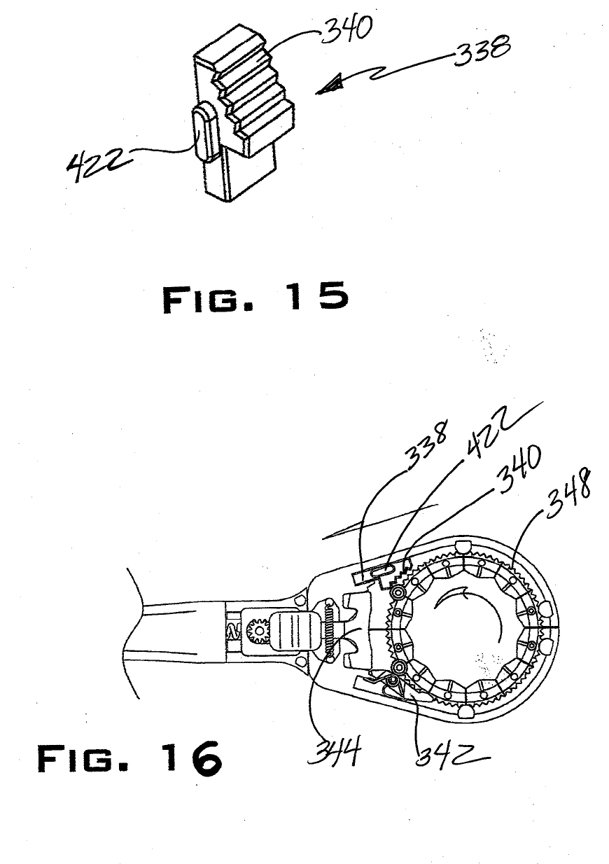

FIG. 15 shows pawl 338 with pawl teeth 340 and ratchet pawl guide 322. Pawl teeth 340 engage the ratchet teeth 348 of FIG. 11, and effect the ratcheting device to make the wrench ratchet against the nut.

FIG. 16 shows a situation where the ratchet teeth 348 and pawl teeth 340 are disengaged. Pawl 338 is not engaging with the ratchet teeth, nor is it preventing lock 344 from moving forward. Lock pawl 342 is in a position so that lock 344 can be pushed forward. Once lock 344 is pushed forward, the clamp housing can open and the wrench can open up. In order to reverse the ratcheting action, the operator merely needs to turn the clamping ratchet wrench over and use it in order to effect a reverse ratcheting motion.

With combined reference to FIGS. 17A and 17B, there are shown a pair of upper and lower lock balls 430 being urged into place by lock ball springs 432. Once alignment guide 326 comes into position where the lock balls 430 can be pushed into the indented portions of the face segment 350, lock balls 430 drop into place within the alignment guide 326 and prevent the ratchet segments 350 from coming out. FIG. 17B shows where the alignment indentation 326 is off center from the lock balls 430 and consequently the ratchet segment 350 is free to move.

FIG. 17C shows the top of ratchet segment 350 as shown in more detail with regard to FIGS. 11A and 11B, showing the ratchet teeth 348 with respect to alignment guide 326 and the ratchet segment face 360. Indentation 450 could not be seen previously in FIGS. 11A and 11B, but is an indentation that will receive lock balls 430. The channel portion 460 rides in a groove created by the clamp housing and the indentation 450 as it rolls around. The indentation receives the lock balls once the wrench is in alignment due to alignment guide 326. At that point, lock ball springs 432 will engage lock balls 430 into indentation 450, thereby locking the segments in place so that they won't come out of the wrench when the wrench is opened up. Regardless of any aspect of the invention, all the individual ratchet segments collectively form a wrench “race”, like ball bearings in a roller skate wheel. The segments rotate freely within the “race”, and ratchet and catch when the pawls connect.

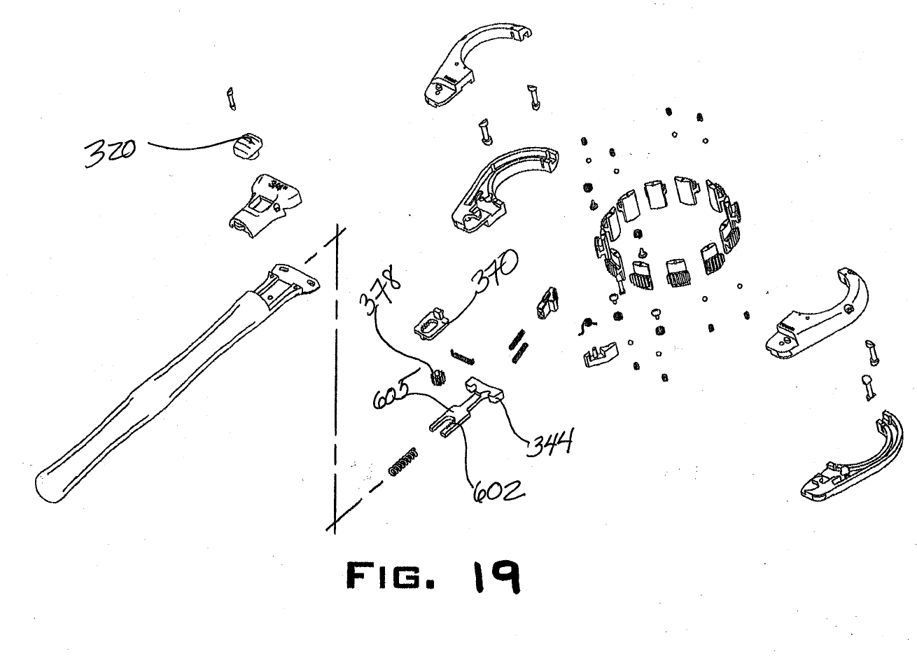

With combined reference again to 18A and 18B, touch pins 328 are shown that were initially illustrated in FIG. 10 as element 328 for the user to feel when he is not able to view the ratchet wrench. When raised up, touch pins 328 indicate to the user that the wrench is in alignment and the wrench ratchet segments 350 are in a position so that he can open the wrench. Touch pins 328 are held in place by touch pin springs 500 which ride along the top of ratchet attachments 350. Looking back to FIG. 11A, one can see the ratchet teeth 348, where the design of the ratchet teeth has a downwardly facing ramp towards the outer edges of the teeth. Looking back to FIG. 18A, once can see that the ratchet segment 350 has an indentation which receives touch pin 328. FIG. 18B shows that when the ratchet segment is not properly aligned, touch pin 328 is extending upwardly and downwardly and the user can feel with his fingers to know that the ratchet segments are not aligned and it is not ready to be opened. Ratchet teeth 348 have a smaller dimension at either end, creating a smaller section 502. When smaller section 502 comes into proper alignment, the touch pin springs 500 push touch pins 328 upwardly and downwardly so that it feels smooth on the surface 600, and the operator will know the ratchet segments are in proper alignment so that he may open the ratchet wrench.

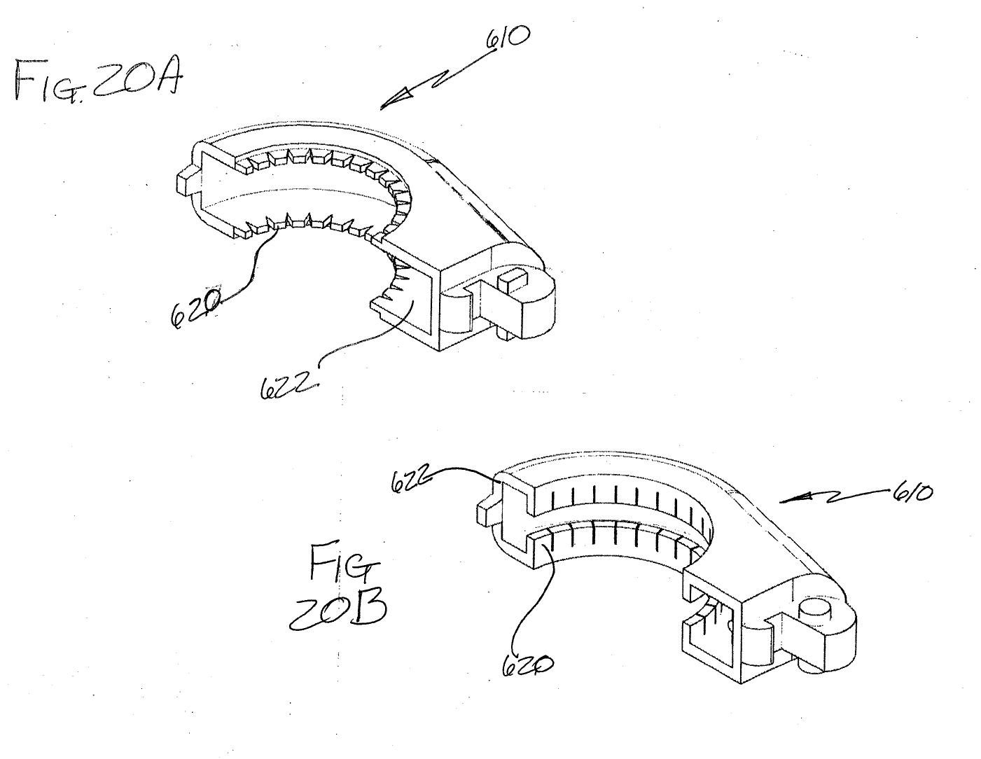

FIG. 19 is an exploded perspective view of all the parts of the working portions of the ratchet wrench made in accordance with the present invention. The one piece that has not been heretofore been shown or described in this disclosure is lock 344 having a distal extension 605 with lock gear teeth 602 on the interior portion that are engaged by lock gear 378, along with release slide 370. Lock gear 378 was previously shown in FIG. 11D with reference to its interaction with release slide 370 of FIG. 11C. However, lock gear 378 also engages the lock gear teeth 602 of lock 344. In operation, lock gear teeth 602 push lock 344 forward when the release slide 370 is urged backward when the retractable button 320 is operated.

FIGS. 20A and 20B show yet another aspect of the present invention detailing a one-piece housing encasing all the internal workings and the ratcheting keys for ease of manufacture and durability. Looking first to FIG. 20A, one half of the wrench head is generally denoted by the numeral 610, illustrating a one piece housing 622 with tabs 620 formed preferably from a forged housing, rather than a top and bottom clamp housing as described hereinabove which needed to be fastened together. Tabs 620 are shown as being formed during the forging process, and this illustration shows them before they are bent into position, as shown in FIG. 20B. Clearly, tabs 620 are formed after all the interior components are placed within the housing.

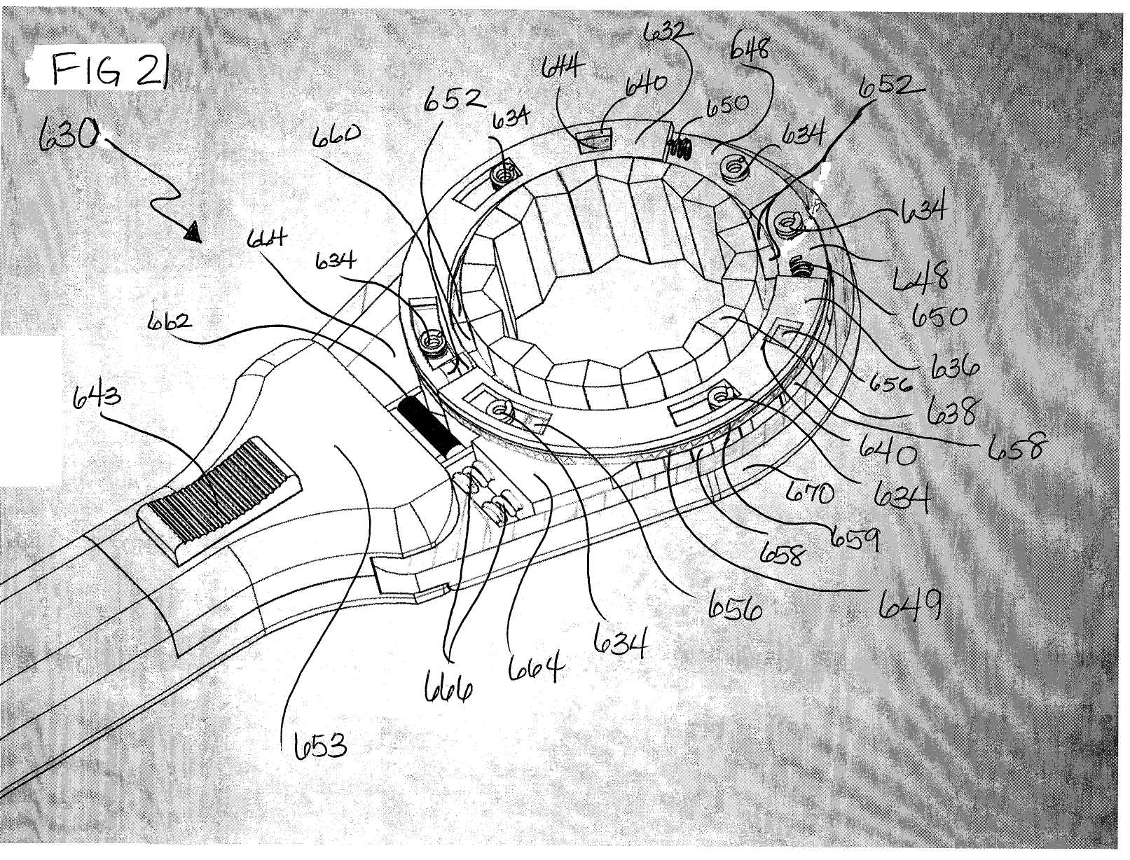

FIG. 21 illustrates the bottom half of the one-piece housing, but with all interior components displayed and described. In essence, this view shows the housing as if it were sliced along its horizontal component, so as to better show the inside. A ratcheting wrench is denoted generally by the numeral 630, and includes, from the bottom up, a cutaway housing half 670 supporting a notched key base 658, described more in later drawings. The notches of notched key base 658 extend upwardly and are met with downwardly extending notches 649 formed into the underside of bottom plate 648, which will be described as providing for the movement of the ratcheting wrench. On top of notched key base 658 rides a complementary set of downward extending notches 649, such that as the wrench is ratcheted, the complementary set of notches end up skipping over one another until they are urged together and pushing against one another.

Still referring to FIG. 21, this wrench configuration parts along lines A-A to open up and surround a nut or other workpiece to be tightened or loosened. Ratchet keys 638 are automatically aligned, and upon pulling back on the pushbutton 643, the halves of the housing 670 are pushed open while all the ratchet keys 638 stay in place by the housing 670, the notched portion 659 of the key base 658 and the downwardly facing notches 649 of notched bottom plate 648. Releasing the pushbutton 643 pulls the two halves of the housing 670 together, and the wrench will make a full rotation ratcheting wrench useful in so many ways. When the pushbutton 643 is pulled back the compression spring between the right and left housing pushes them open. When the pushbutton 643 is released the spring in the wrench handle drives the piece that the button is attached to between the right and left housing which forces it to close.

In operation, the wrench of FIG. 21 utilizes a series of lifting springs 634 interspersed throughout the circumference of the housing 670. Lifting springs 634 are attached to the notched bottom plate 648, and they urge upwardly against right and left top plates 632 and 636 respectively. We differentiate between right top plate 632 and left top plate 636, as each can act independently, since wrench 630 opens up, leaving plates 632 and 636 as separate pieces. Of course, these top and bottom plates end up being covered by the top of the one-piece housing, it is just not shown in these drawings, or else one could not see inside the housing. Referring back to FIG. 20A-B, the housing is formed around the interior components. So, during operation, after the wrench has been closed around the workpiece to be tightened (not shown in this drawing), lifting springs 634 urge the top of the notched key bases 658 against the downwardly facing bottom plate 648, engaging the two together except when the force of ratcheting pushes them apart, allowing the ratchet to work.

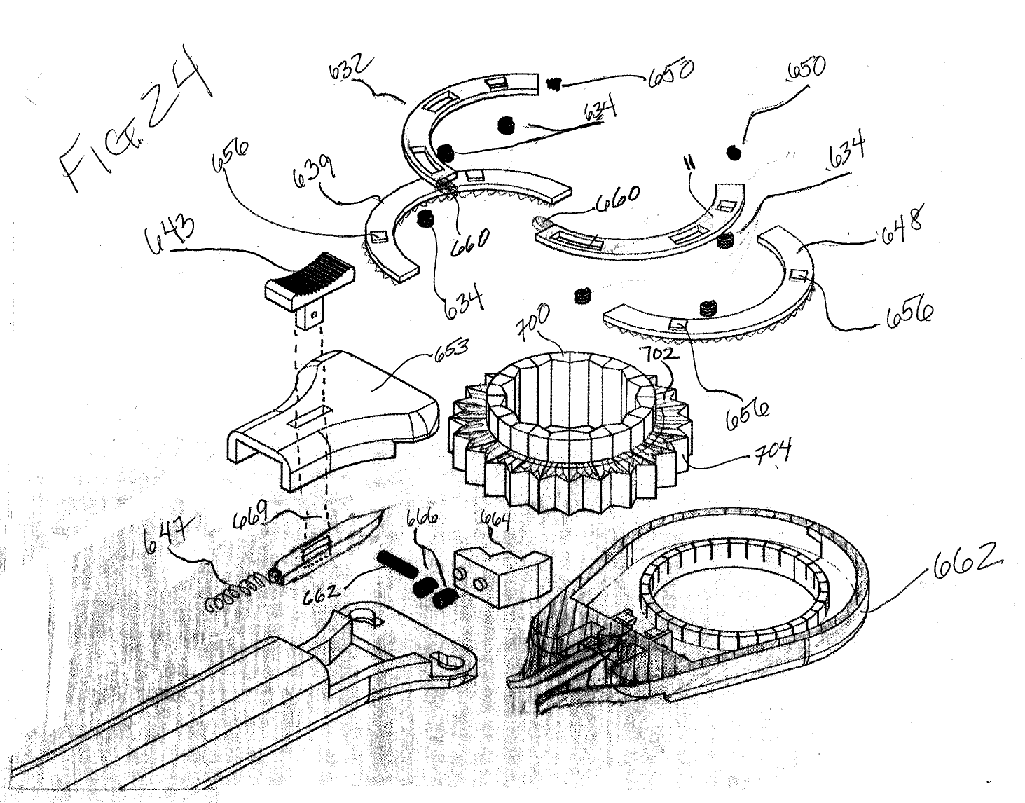

At the proximate end of each of the top plates is a rounded tip 660 approximately one half of the width of the top plate piece (see FIG. 24), and these rounded tips 660, when the wrench is in the closed position, push against the opposing top plates 632 and 636 to force them in the counter clockwise and clockwise positions respectively, and align open recesses 640 in the top plate with the locators 656 extending upwardly from bottom plate 648. The recesses 640 in the top plate allow bottom plate 648 to move up and down as the ratchet keys 638 rotate. When the wrench is in the open position, springs 634 force top plates 632 and 636 in a clockwise direction, and push recesses 640 past the locators 656 in bottom plate. The locators 656 are now pressed firmly against top plates 632/636 and lock into the recesses 640 in bottom plate 648 firmly against the ratchet keys 638. The prevents the ratchet keys from rotating.

In activating the ratchet action, pawl 664 is urged into position by pawl springs 666. At the ratchet keys rotate, pawl 664 rides along the surfaces of key bases 658, providing a surface to push against. As top plates 632/636 move up and down during ratcheting, some of the recesses 640 are sufficiently sized to accommodate not only lifting springs 634, but also locators 656. However, in this preferred aspect, one of the recesses 640 are small enough to merely receive one locator 656, without enough space for a lifting spring 634. As the top plates 632/636 rotate, the single locator 656 received within the smaller recess 640. Once the locator 656 is engaged within recess 640, it acts as a pathway for the locator 656 to move up and down through during ratcheting.

Transverse springs 650 shown extending laterally from the side of top plates 632/636 engage with a downwardly facing wall from the top of the clamp housing (not shown since this is an open diagram, and they act to keep all the various components in place when the wrench is in the open position. Without these transverse springs 650, it is possible that the top plates 632/636 would disengage from the bottom plates 648, and the ratchet keys 638 would become dislocated.

Still referring to FIG. 21, there is shown a compression spring 662 which is always urging outwardly from its center, and this compression spring 662 pushes the right and left housing halves apart when the pushbutton 643 is pulled back, thereby opening the wrench along parting lines A-A. Pushbutton 643 is located within handle housing 653 for securement.

Looking next to FIG. 22, where like element numbers are used to describe the various components along with those of FIG. 21, there can be seen a side elevational view of the wrench cut through the one-piece housing, in order to clearly see all the pieces that would be covered up by the remainder of the housing. It may be easier to see that ratchet key 638 not only extends up into the housing, but the notched key base 658 extends down into the housing 670. Starting at the bottom, housing 670 has notched key base 658 with upwardly extending notches 659 engaging with the downwardly extending notches 649 of bottom plate 648. Locators 660 extend upwardly into recess 640, and are permanently affixed on top of bottom plate 648. Lifting springs 634 are received into recesses 640 cut into top plates 632/636. On top of that, the top of ratchet keys 638 can be seen. Pushbutton 643 is located within the handle of the wrench.

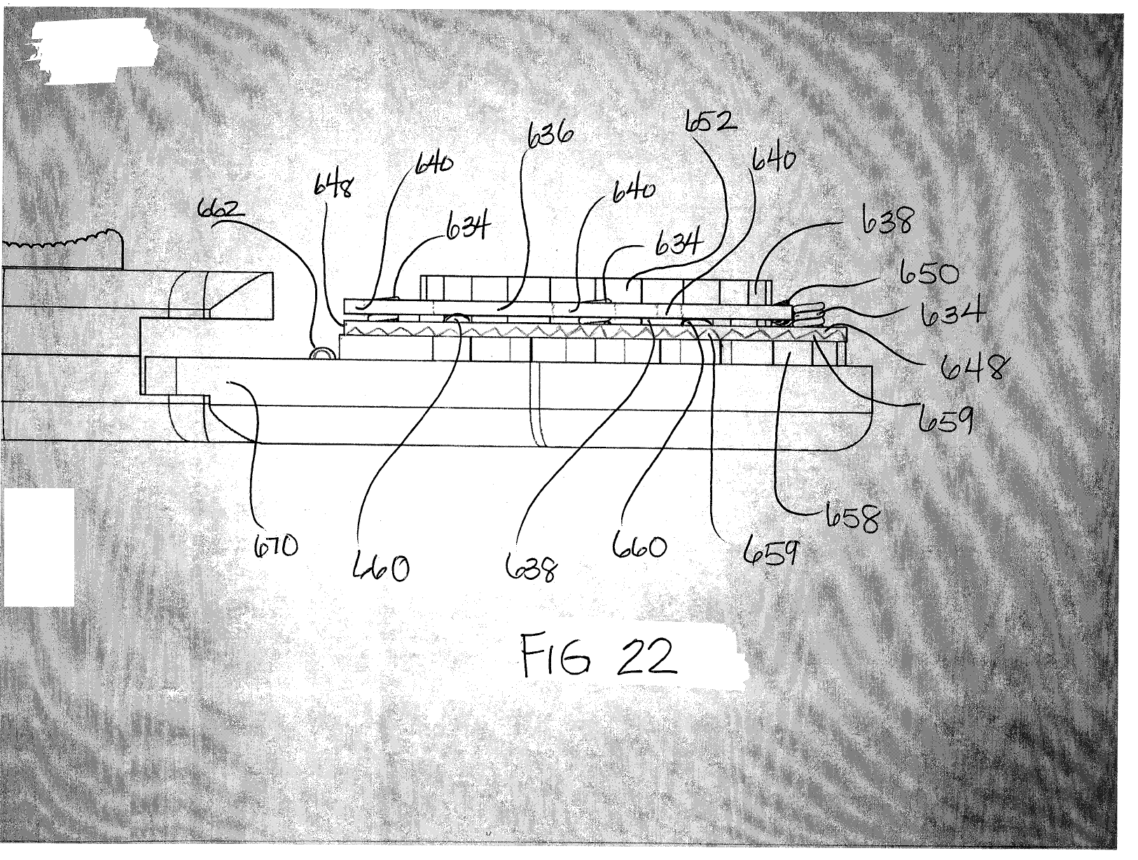

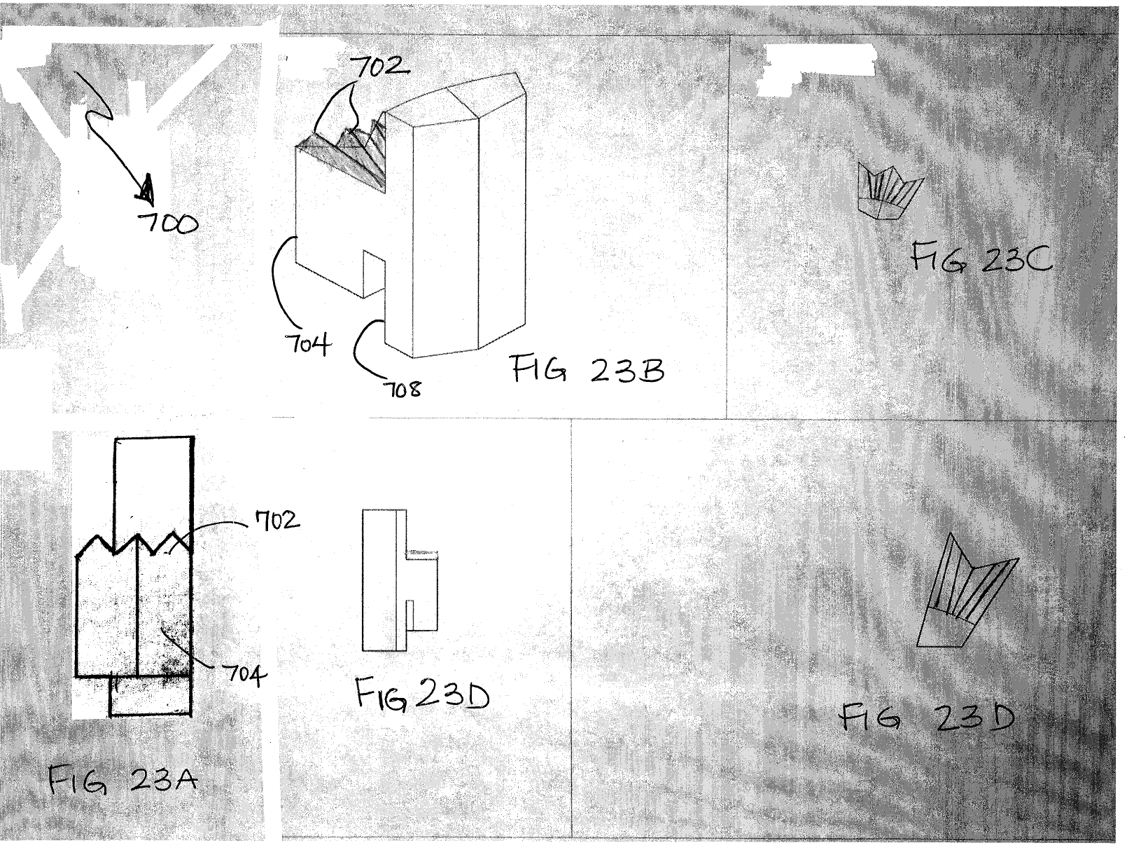

Referring collectively to FIGS. 23A-E, there is illustrated a single key segment 700 that is preferable for use in this aspect of my invention. In the forward extending portion, key face 704, there are notches 702 extending upwardly. FIG. 23B shows two complementary key segments aligned such that notches 702 extend upwardly, while key faces 710 face the interior of the wrench, to be used for engaging a workpiece. Along the line of the key faced 710, a downwardly extending portion 708 acts as a skag to be engaged in the wrench. FIG. 23C shows a top plan view of the notched portion of a key shown in FIG. 23A. FIG. 23 C shows two individual keys put together. FIG. 23 E shows a single key segment from the top, while FIG. 23D shows a side elevational view of key 700. FIG. 23D more clearly shows skag 708, which is the piece that maintains the position of key 700 within the housing. Clearly, every time the wrench ratchets, the segment keys automatically align up, such that when the wrench is opened, the segment keys do not fall out.

FIG. 24 is an exploded view of the above described wrench, and utilizes the same element numbers are in previous descriptions. Further in this diagram, it can be seen that wedge 669 receives a skag from pushbutton 643, and that this movement urges wedge 669 forward into the housing 662, pushing the two halves of housing 662 apart. When not being pushed forward by the skag of pushbutton 643, an attached spring 647 retreats wedge 669, thereby allowing the wrench to return to its closed position. Keys 700 are shown more fully in FIG. 24, where the upwardly extending notches 702 are on top of key base faces 704. It can be seen that the notches 702 on keys 700 engage with the downwardly facing notches of bottom plate 648. As the keys rotate during ratcheting, pawl 664 engages the key base faces 704, thereby effecting the ratcheting process.

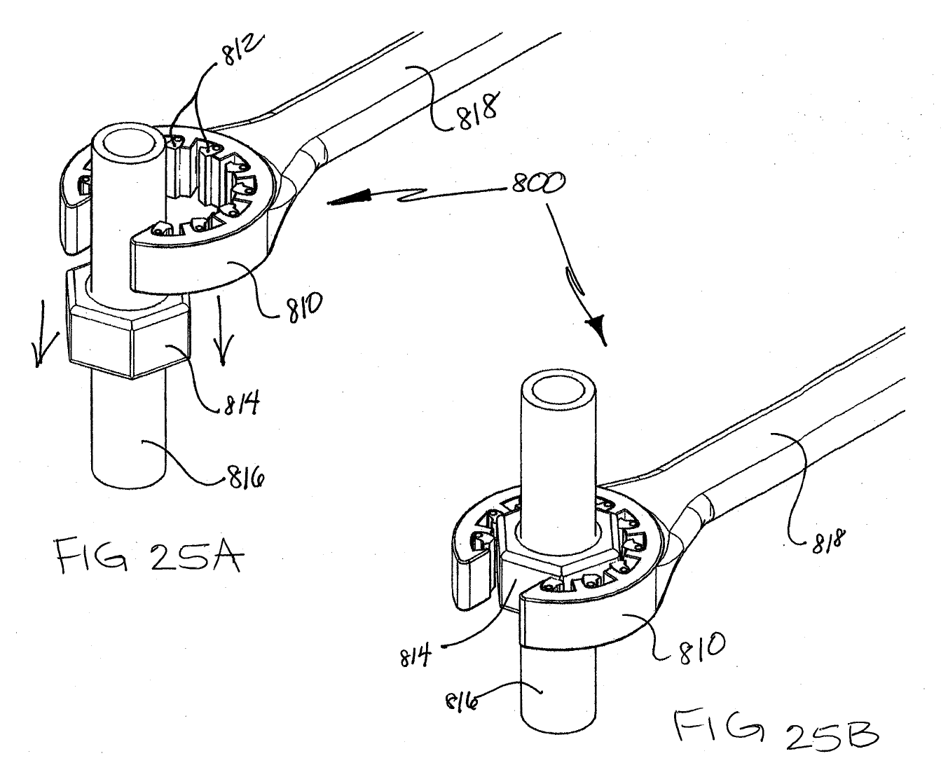

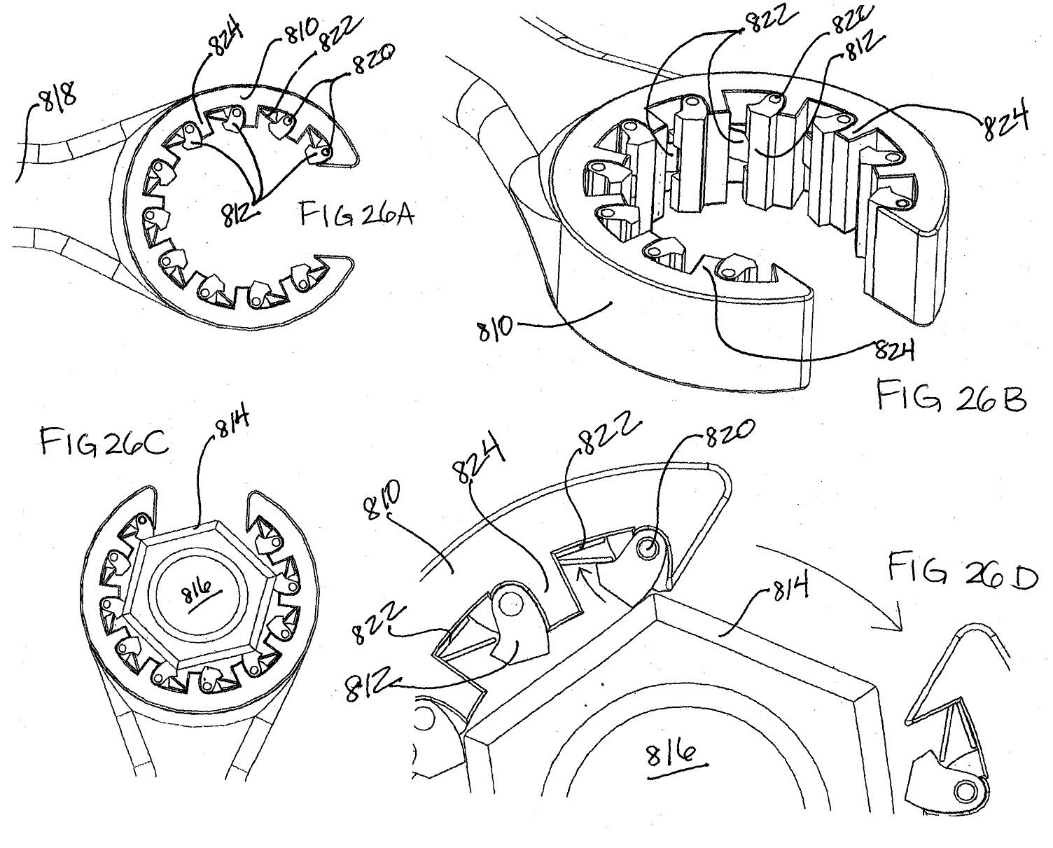

Looking now to the environmental views of FIGS. 25A and 25B, yet another aspect of the present invention is shown of yet another type of open ended ratcheting wrench 800, including a one-piece wrench housing 810 surrounding ratchet keys 812 to be placed around a nut 814 that needs to be tightened or loosened on a pipe 816. Handle 818 is used to urge this open ended ratcheting wrench into place. In this aspect, a novel concept of ratcheting keys is shown where an interior race channel is unnecessary. This aspect is different from my other aspects because this wrench does not form a full rotation around the nut being tightened, nor does it function like a traditional ratchet as it does not rely on the use of a pawl to work. Rather, this wrench has individual ratchet segments that ratchet on the nut itself to allow it to rotate around the nut in one direction and lock to tighten when rotated in the opposite direction. Ratchet keys 812 become actuated as they pivot on pivot pins and urged back into place by individual springs. These will all be described in greater detail with reference to FIGS. 26A through 28.

Collectively referring next to FIGS. 26A-26D, various views of this aspect of the present invention can be seen. In all views, like element numbers are used to describe ratchet wrench 800 having a handle 818, and further including individually pivoting ratchet keys 812 pinned to housing 810. Ratchet key pivot pins 820 holds ratchet keys 812 in place. Individual ratchet springs 822 urge each of the pivoting ratchet keys 812 back into position against housing skag 824. Thus, the ratchet key segments 812 can only be rotated clockwise on their respective pin axes, although not counter clockwise. They lock to tighten the nut when rotated in the counterclockwise direction. In order to loosen the nut, the operator merely has to remove the wrench and turn it over to provide ratcheting in the other direction.

FIG. 26B shows the relative placement of springs 822 as they are secured within indents in the body of ratchet keys 812. Each ratchet key 812 has its own spring 822, in order to urge it back into position after ratcheting. Ratchet keys 812 are forced back against housing skags 824 to provide a solid surface for forcing against the nut 814, as shown in FIG. 26C and 26D. Nut 814 surrounds pipe 816, so a line wrench is needed, or else the pipe must be disassembled.

FIG. 26D shows the concept during a ratcheting operation, where the apex of the nut makes the ratchet key 812 pivot on pivot pin 820 to pivot inward toward the spring 822, and after the apex of the nut has passed due to ratcheting, spring 822 urges key 812 back into position so that nut 814 can be forced against housing skag 824, and providing a solid surface to tighten the nut.

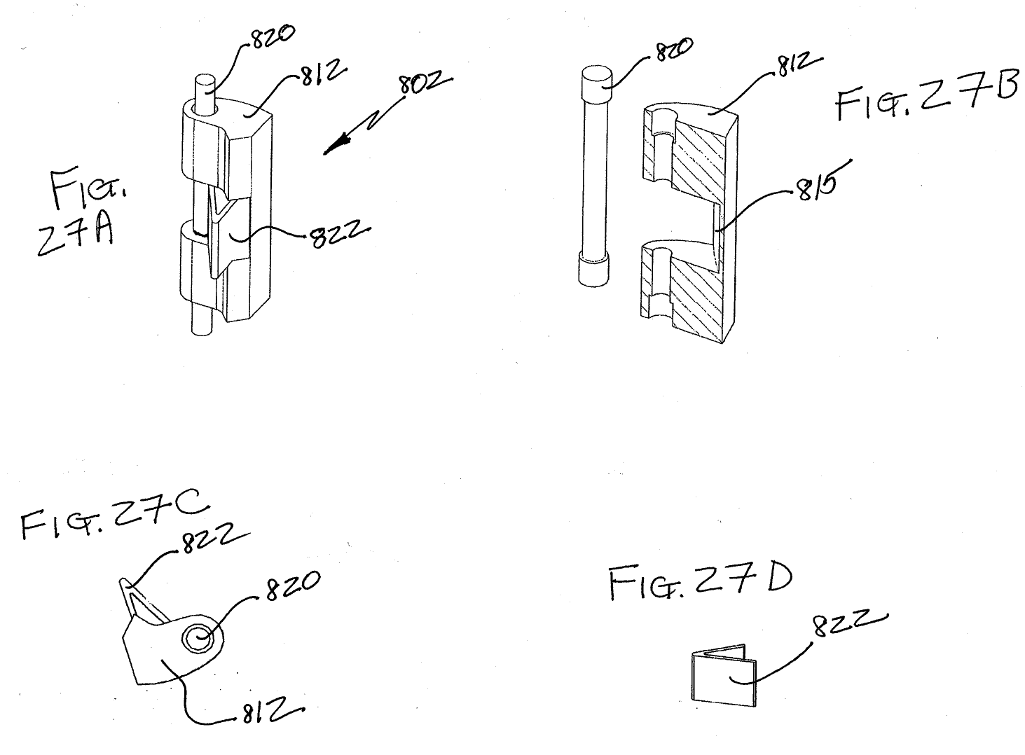

FIGS. 27A through 27D illustrate the individual components of this aspect. A partially assembled ratchet key segment is generally denoted by numeral 802, and includes ratchet key segment 812 having pivot pin 820 inserted therethrough. Pivot pin 820 is preferably a steel pin to be inserted through the ratchet key 8123 and a complementary hole in the wrench housing (not shown). Pivot pin 820 can be machine pressed into place. Spring 822 is preferably a steel spring clip readily available commercially, and spring 822 is held in place within ratchet key segment 812. FIG. 27B shows a cutaway view of the interior of ratchet key segment 812 and illustrates indent 815. FIG. 27C shows a top plan view of ratchet key segment 812 with pivot pin 820 in place and spring 822 extending radially therefrom. FIG. 27D shows an individual spring 822 from the side.

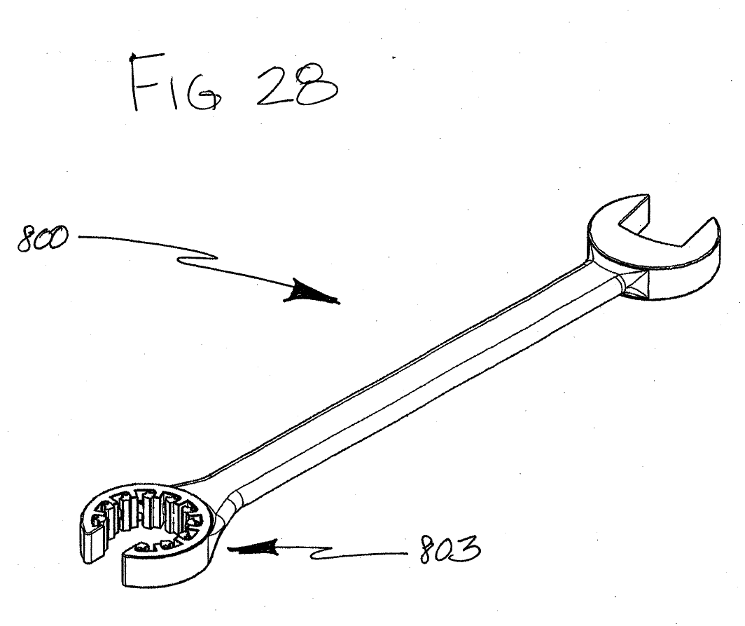

FIG. 28 shows a double ended wrench incorporating a traditional crescent wrench.

The foregoing description of various aspects of the invention have been presented for purposes of illustration and description. They are not intended to be exhaustive or to limit the invention to the precise form disclosed. Obvious modifications or variations are possible in light of the above teachings with regards to the specific embodiments. The aspects were chosen and described in order to best illustrate the principles of the invention and their practical applications to thereby enable one of ordinary skill in the art to best utilize the invention in its various aspects and with various modifications as are suited to the particular use contemplated.

### INDUSTRIAL APPLICABILITY

The present invention finds applicability in the hand tool industry, and especially in the ratcheting wrench segment, where it is desirable to have an open ended ratcheting wrench for mid-pipe fastener manipulation without having to open up the pipe midway to tighten or loosen a nut usually.

What is claimed is:

1. A one piece housing surrounding an open-ended clamping ratcheting wrench having an open position and a closed position for applying pressure around an article to be tightened, being a fastener such as a bolt or nut, when the wrench is in the closed position, comprising:
a one piece clamp housing having formable tabs that can be formed into a single piece covering, wherein said clamp housing defines an interior race channel;
at least two notched pieces, including plates for engaging;
a plurality of individual ratchet segments having segment faces and integral gear teeth, all of said segments being contained and rotatable within the interior race channel inside the clamp housing when in the closed position, such that the plurality of segment faces collectively face toward the interior of the opening of the wrench, resulting in a socket shape configuration when the wrench is in the closed position, said socket shape configuration being capable of gripping and ratcheting the fastener;
a handle having a longitudinal axis and being attached to and supporting the clamp housing, said handle embodying a retractable latch button for urging the at least one side portion of the clamp housing interchangeably between the open and closed positions; and
at least one pawl for engaging with the gear teeth, such that the gear teeth of the ratchet segments mate against the surface of the pawl to enable ratcheting, wherein both of the side portions of the clamp housing pivot proximate the handle, and the open position of the clamp housing of the wrench is adapted for opening up along the longitudinal axis of the handle, such that the wrench can be used to approach a workpiece head on for ease of use.

2. The open-ended clamping ratcheting wrench of claim 1, wherein the clamp housing is formed around the segments, while forming the interior race channel.

3. The open-ended clamping ratcheting wrench of claim 1, wherein the pivotable side portion of the clamp housing opens and separates from the other side portion of the clamp housing along a longitudinal axis of the handle to put the wrench in an open position.

4. The open-ended clamping ratcheting wrench of claim 1, further comprising a retractable push button located within the handle, and wherein the retractable push button pivots the clamp housing to urge the side portions together and automatically lock the segments into the closed position for ratcheting.

5. The open-ended clamping ratcheting wrench of claim 1, wherein the clamp housing side portions are hinged proximate the handle.

6. The open-ended clamping ratcheting wrench of claim 1, wherein the segments include interlocking ratchet keys to be held by the pawl, thereby enabling ratcheting of the wrench.

7. The open-ended clamping ratcheting wrench of claim 1, wherein the segments themselves are located within the interior race channel and form the resulting ratcheting socket.

8. The open-ended clamping ratcheting wrench of claim 1, wherein the wrench is adapted to be a line wrench.

9. The open-ended clamping ratcheting wrench of claim 1, wherein the wrench is adapted to ratchet a bolt.

10. The open-ended clamping ratcheting wrench of claim 1, wherein the wrench is adapted to ratchet a nut.

11. The open-ended clamping ratcheting wrench of claim 1, wherein said at least one pawl engages the gear teeth of the segments to allow rotation of the ratchet segments within the race channel of the clamp housing in one direction of rotation and to prevent rotation in the opposite direction.

12. The open-ended clamping ratcheting wrench of claim 1, wherein the at least one pawl is kept in place by a pawl spring.

13. The open-ended clamping ratcheting wrench of claim 1, wherein the at least one pawl is automatically engaged with the gear teeth of the ratchet segments, such that the gear teeth of the ratchet segments mate against the surface of the pawl to enable ratcheting.
